(19) United States
(12) Patent Application Publication
(10) Pub. No.: US 2003/0221757 A1
(43) Pub. Date: Dec. 4, 2003

(54) Tire

(76) Inventor: Shut Chen Hsu, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/349,965

(22) Filed: Jan. 24, 2003

Related U.S. Application Data
(63) Continuation-in-part of application No. 10/157,149, filed on May 30, 2002.

(51) Int. Cl. B60C 17/04

(52) U.S. Cl. 152/158; 152/520

(57) ABSTRACT

A tire is constructed to include a main tire member, the main tire member having two inward lips and transverse air holes and screw holes extended through the inward lips, two supplementary tire members respectively adhered to the inward lips of the main tire member on the inside of the main tire member, and a plurality of screws respectively threaded into the screw holes of the supplementary tire members and engaged into respective recessed holes in the inward lips.

### CROSS-REFERENCE TO RELATED APPLICATION

The present invention relates to in a continuation-in-part of application Ser. No. 10/157,149, entitled “TIRE”.

### BACKGROUND OF THE INVENTION

1. Field of the Invention

The present invention, which improves the design of application Ser. No. 10/157,149, relates to vehicle tires and, more particularly, to a vehicle tire, which supports the tire for normal functioning for a length time when the tire damaged accidentally.

2. Description of the Related Art

For a safety driving, the condition of vehicle tires must be regularly checked. There are two kinds of vehicle tires used in existing motorcars, namely, the tire having an inner tube, and the tire without inner tube. According to conventional tire designs, a meshed metal wire structure formed of transverse metal wires and a longitudinal metal wires is arranged in between the carcass and the tread. The two layers of metal wires are arranged at 17˜26°. This meshed metal wire structure can only reinforce the structural strength of the tire. It cannot protect the tire against piercing of an external sharp object. When a nail or the like pierced through the open spaces in the meshed metal wire structure, the tire leaks, and a tire explosion accident may occur.

### SUMMARY OF THE INVENTION

The present invention has been accomplished to provide a tire, which eliminates the aforesaid problems. According to one aspect of the present invention, the tire comprises a main tire member, the main tire member having two inward lips and transverse air holes and screw holes extended through the inward lips, two supplementary tire members respectively adhered to the inward lips of the main tire member on the inside of the main tire member, and a plurality of screws respectively threaded into the screw holes of the supplementary tire members and engaged into respective recessed holes in the inward lips. According to another aspect of the present invention, the supplementary tire members have embedded therein reinforcing steel wires and meshed reinforcing members. In an alternate form of the present invention, the supplementary tire members are respectively formed integral with the inward lips of the main tire member.

### BRIEF DESCRIPTION OF THE DRAWINGS

FIG. 1 is an exploded view in section of the present invention.

FIG. 2 is an assembly view in sectional elevation of the present invention.

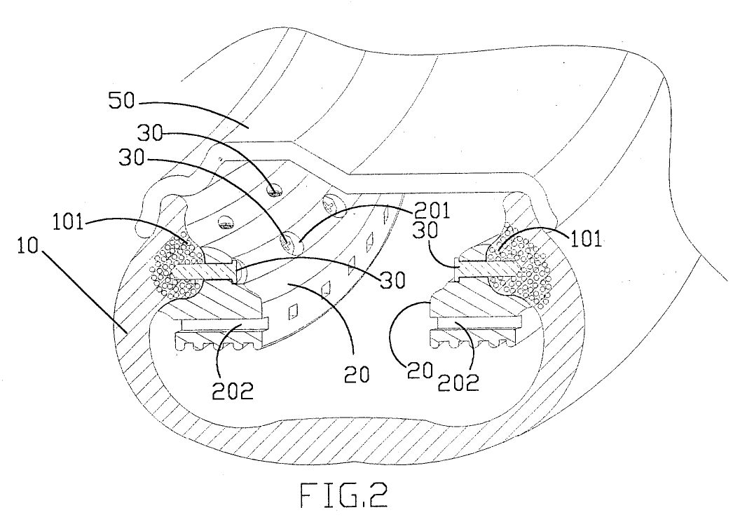

FIG. 3 is a sectional view of the present invention, showing the main tire member flattened.

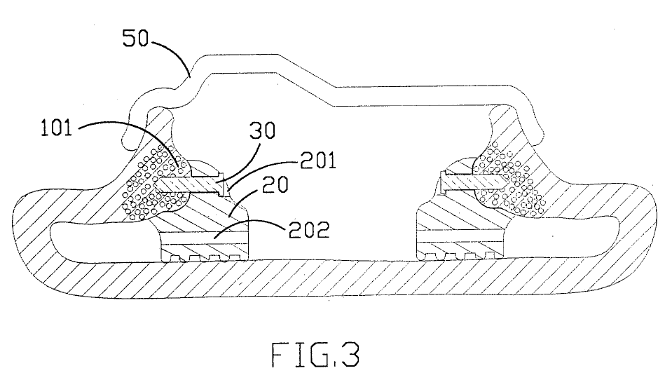

### DETAILED DESCRIPTION OF THE PREFERRED EMBODIMENT

Referring to FIGS. from 1 through 3, a tire in accordance with the first embodiment of the present invention is shown comprised of a main tire member 10 and two annular supplementary tire members 20 bilaterally fastened to the inside of the main tire member 10.

The main tire member 10 has embedded therein reinforcing steel wires and meshed reinforcing members (not shown), comprising two inward lips 101 respectively inwardly protruded from the two opposite sidewalls thereof and a plurality of recessed holes (not shown) in the inward lips 101.

The supplementary tire members 20 each comprise an endless groove 203 extended along one of the two opposite lateral sidewalls thereof, a plurality of transverse screw holes 201 extended through the two opposite lateral sidewalls in communication with the endless groove 203, and a plurality of transverse air holes 202 transversely extended through the two opposite lateral sidewalls for ventilation and heat dissipation. Further, the supplementary tire members 20 each have a bottom sidewall corrugated.

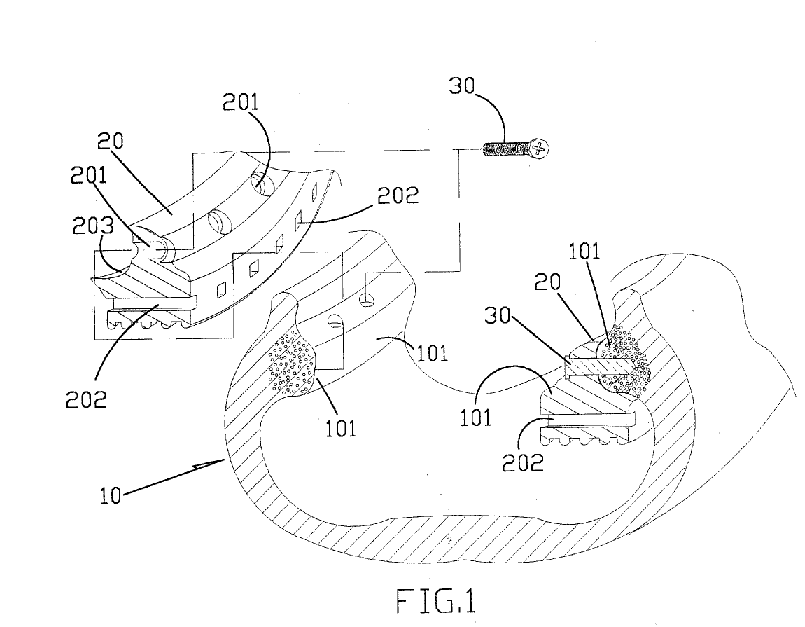

Referring to FIGS. 1˜3 again, the inward lips 101 of the main tire member 10 and the endless grooves 203 of the annular supplementary tire members 20 are covered with a layer of glue, and then the endless grooves 203 of the annular supplementary tire members 20 are respectively adhered to the inward lips 101 of the main tire member 10, and then screw 30 are respectively threaded into the screw holes 201 of the supplementary tire members 20 and engaged into the respective recessed holes in the inward lips 101 to fixedly secure the supplementary tire members 20 to the inside of the main tire member 10, and then the main tire member 10 is fastened to a wheel rim 50, forming with the wheel rim 50 a vehicle tire. In case the main tire member 10 exploded due to an accident, the supplementary tire members 20 support the main tire member 10 in shape, enabling the car to be continuously driven to the repair shop safely to receive a repair work.

It is to be understood that the drawings are designed for purposes of illustration only, and are not intended for use as a definition of the limits and scope of the invention disclosed.

What the invention claimed is:

1. A tire comprising:
a main tire member main tire member, said main tire member having embedded therein reinforcing steel wires and meshed reinforcing members, two inward lips respectively inwardly protruded from the two opposite sidewalls thereof, and a plurality of recessed holes in said inward lips;
two annular supplementary tire members respectively bilaterally fastened to the inside of said main tire member, said supplementary tire members each comprising an endless groove extended along one of two opposite lateral sidewalls thereof and adhered to one inward lip of said main tire member, a plurality of transverse screw holes extended through said two opposite lateral sidewalls in communication with said endless groove, and a plurality of transverse air holes transversely extended through said two opposite lateral sidewalls; and
a plurality of screws respectively threaded into the screw holes of said supplementary tire members and engaged into the recessed holes of the inward lips of said main tire member.

2. A tire comprising:
a main tire member main tire member, said main tire member having embedded therein reinforcing steel wires and meshed reinforcing members, two inward lips respectively inwardly protruded from the two opposite sidewalls thereof; and
two annular supplementary tire members respectively formed integral with the inward lips of said main tire member and adapted to support said main tire member in shape, said supplementary tire members each comprising a plurality of transverse air holes transversely extended through said two opposite lateral sidewalls.
